(19) United States
(12) Patent Application Publication
(10) Pub. No.: US 2023/0229222 A1
(43) Pub. Date: Jul. 20, 2023

(54) VOLTAGE PROTECTION

(71) Applicant: Intel Corporation, Santa Clara, CA (US)

(72) Inventors: Alexander UAN-ZO-LI, HILLSBORO, OR (US); Sameer SHEKHAR, PORTLAND, OR (US); Michael ZELIKSON, HAIFA (IL); Boaz HIRSCHL, BERROTAIM (IL); Nimrod ANGEL, HAIFA (IL); Sagi SABAG, Haifa (IL)

(21) Appl. No.: 18/010,191

(22) PCT Filed: Jul. 13, 2020
(86) PCT No.: PCT/US2020/041833

§ 371 Date: Dec. 13, 2022

(51) Int. Cl. G06F 1/30; G06F 1/28

(52) U.S. Cl. CPC G06F 1/305; G06F 1/28

(57) ABSTRACT

Embodiments of the present invention provide a voltage protection apparatus (130, 160, 205, 630, 730), comprising an input (165, 210, 610, 710) to receive an input voltage provided to a processor (120), an output (190, 260, 680, 760) to output a throttle signal to the processor (120), a filter circuit (180, 240, 640, 660, 740) to filter the input voltage provided to the processor (120) to provide a filtered input voltage, and a first circuit (170, 230, 630, 650, 73) to compare the filtered input voltage to a first threshold voltage (175, 235, 635, 645, 735) and to cause the output (190, 260, 680, 760) to provide the throttle signal to the processor (120) indicative of the filtered input voltage dropping below the first threshold voltage.

### TECHNICAL FIELD

Embodiments described herein generally relate to voltage protection. More particularly, although not exclusively, embodiments relate to voltage protection of a processor to protect an input voltage to the processor.

### BACKGROUND

It is necessary to ensure that a supply voltage to a processor is maintained above a minimum supply voltage to avoid black-screening i.e. the processor at least partially failing to operate correctly. As a current consumption of the processor varies, particularly increases, the supply voltage provided as an input to the processor may drop or droop. The processor may consume a peak current during high workload which vastly exceeds a current consumed during normal workload of the processor. To ensure the supply voltage to the processor is maintained above the minimum supply voltage, a voltage regulator providing the supply voltage to the processor may output the supply voltage substantially higher than the minimum voltage, which results in additional power consumption and/or heating.

### BRIEF DESCRIPTION OF THE DRAWINGS

Embodiments described herein are illustrated by way of example, and not by way of limitation, in the figures of the accompanying drawings in which like reference numerals refer to similar elements:

FIG. 1 illustrates a block diagram of a voltage protection apparatus according to an embodiment of the invention;

FIG. 2 schematically illustrates a voltage protection apparatus according to an embodiment of the invention;

FIG. 3 illustrates a method according to an embodiment of the invention;

FIG. 4 schematically illustrates a voltage protection apparatus according to another embodiment of the invention;

FIG. 5 illustrates example impedance between a voltage regulator and processor;

FIG. 6 illustrates impedance against frequency for the example circuit of FIG. 5;

FIG. 7 illustrates operation of the voltage protection apparatus according to an embodiment of the invention;

FIG. 8 schematically illustrates a voltage protection apparatus according to another embodiment of the invention; and

FIG. 9 schematically illustrates a voltage protection apparatus according to another embodiment of the invention.

### DESCRIPTION OF EMBODIMENTS

Illustrative embodiments of the present disclosure include, but are not limited to apparatus, systems, methods, and machine readable instructions for voltage protection. Some embodiments relate to voltage protection to improve provision of a supply voltage to a processor. Some embodiments relate to voltage protection which throttles a processor in order to improve provision of a supply voltage to a processor. The throttling of the processor may reduce a risk of the supply voltage drooping below a minimum supply voltage.

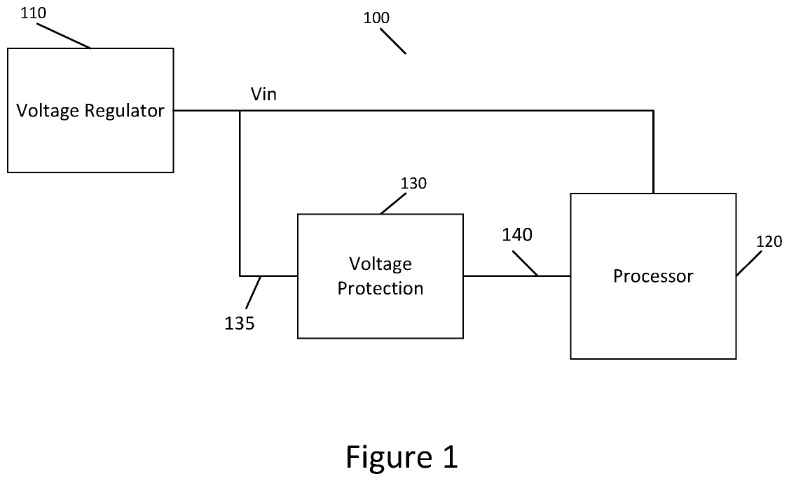

FIG. 1 is a block diagram of an example voltage protection system 100. The voltage protection system 100 comprises a voltage regulator (VR) 110, a processor 120 and a voltage protection apparatus 130 according to an embodiment of the invention. It will be appreciated that the blocks in FIG. 1 may be located or integrated on a semiconductor die, or some blocks may be located on respective other semiconductor dies or on a motherboard or other circuit boards supporting the processor 120. In some embodiments, the VR 110 may be on the same die as the processor 120. The voltage protection apparatus 130 may also be co-located on the die.

The processor 120 may be a central processing unit (CPU), a processor core or a system on chip (SoC). The VR 110 provides electrical power for the processor 120. The VR 110 operatively supplies an input voltage Vᵢₙ to processor 120. The input voltage provided by the VR 110 may be set by the processor 120 i.e. Vᵢₙ may be dynamically set by the processor 120. If Vᵢₙ droops i.e. temporarily drops below a minimum supply voltage, Vₘᵢₙ, the processor 120 may ‘black-screen’ i.e. crash. A current consumed by the processor 120, I_{CPU}, varies over time, such as according to a workload of the processor 120. A peak current consumption of the processor 120, I_{PEAK}, may be significantly greater than a current consumption of the processor 120 during a normal expected use case of the processor 120. To counter the variability of the current consumption of the processor 120, the input voltage provided by the VR 110 may be significantly higher than Vₘᵢₙ i.e. Vᵢₙ>>Vₘᵢₙ which can result in increased power consumption by the processor 120 and may result in one or both of heating of the processor 120 and a limitation of a peak operating frequency of the processor 120.

The voltage protection apparatus 130 monitors Vᵢₙ provided by the VR 110 as an input 135. The voltage protection apparatus 130 asserts a throttle signal 140 to the processor 110 to throttle the processor 120 with the aim of preventing the input voltage to the processor 120 Vᵢₙ drooping below Vₘᵢₙ. The voltage protection apparatus 130 may assert the throttle signal 140 according to a voltage level of the input voltage to the processor 120 as will be explained. In this way, the input voltage during normal use provided by the VR 110 to the processor 120 may be reduced with respect to Vₘᵢₙ, which may thereby reduce one or both of power consumption and heating of the processor 120 during such a normal profile of operation.

Throttling the processor 120 may include, for example, adjusting a clock speed of the processor. This can also be referred to, for example, as dynamic frequency scaling. Processor throttling (for example, Central Processing Unit throttling) can be used to automatically slow down the processor in order to use less energy and conserve battery, for example. Processor throttling can include adjusting the frequency of the processor 120, which can help to conserve power and to reduce the amount of heat generated by the processor, for example. Throttling the processor can also include stopping of execution of certain instructions (for example, stopping execution of instructions that are not providing a lot of value). Throttling of the processor 120 may also include addition of instructions in the pipeline that are known to require little energy.

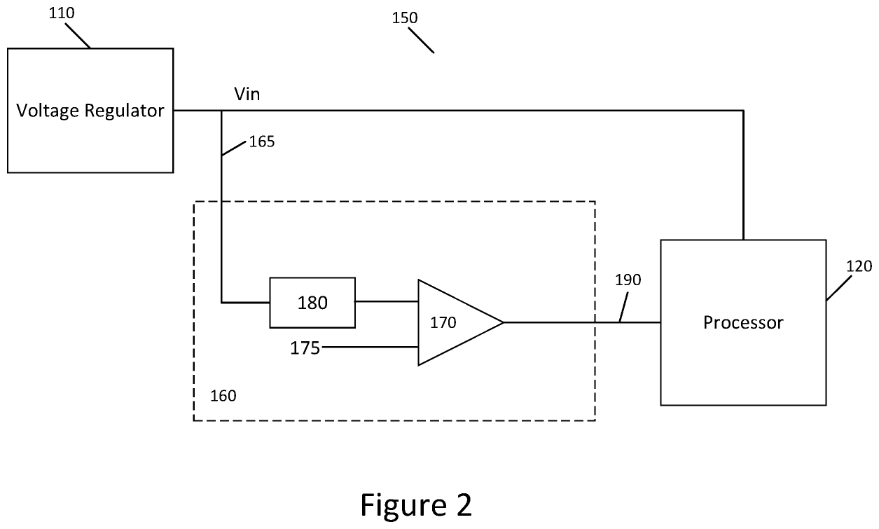

FIG. 2 schematically illustrates an embodiment of a voltage protection system 150, such as that shown in FIG. 1. The voltage protection system 150 comprises the VR 110, the processor 120 and a voltage protection apparatus 160 as described above. The voltage protection apparatus 160 comprises an input 165 to receive a signal indicative of the input voltage Vᵢₙ. The voltage protection apparatus 160 comprises an output 190 to output a throttle signal to the processor 120. The throttle signal 190 is output in dependence on the input voltage Vᵢₙ to the processor 120.

The voltage protection apparatus 160 comprises a filter circuit 180 to filter the signal indicative of the input voltage Vᵢₙ provided to the processor 120 to provide a filtered input voltage V_{fil}. The voltage protection apparatus comprises a circuit 170 to compare the filtered input voltage to a threshold voltage 175. The circuit 170 to compare the filtered input voltage to the threshold voltage 175 comprises a comparator 170. The filter circuit 180 comprises a filter 180, an output of which is provided to the comparator 170. A frequency response profile of the filter 180 may be determined according to characteristics of the processor 120, an electrical network associated with the processor 120, as will be explained, or an expected workload of the processor 120. In some embodiments, a frequency response profile, including one or more cut-off frequencies of the filter 180 may be determined by the processor 120. The filter 180 may be one of a low-pass filter (LPF), a band-pass filter (BPF), a band-stop filter (BSF) or a high-pass filter (HPF). A choice of filter 180 may be made in dependence on characteristics of the processor 120, an electrical network associated with the processor 120 or an expected workload of the processor 120. The type and/or frequency response of the filter 180 may be selected dependent on an expected nature of a potential hazard event. For example, if the processor 120 is found to be sensitive to input voltage fluctuations belonging to a certain frequency band, a BPF may be used; or, if a response of the processor 120 to high frequency stimuli is already factored in a testing process a low pass filter may be utilized.

The comparator 170 is arranged to compare the filtered input voltage to the threshold voltage 175 and to cause the output 190 of the voltage protection apparatus 160 to provide the throttle signal to the processor 120 indicative of the filtered input voltage dropping below first threshold voltage 175. The threshold voltage 175 may be selected in dependence on characteristics of the processor 120, an electrical network associated with the processor 120 or an expected workload of the processor 120. In some embodiments, the threshold voltage 175 may be controlled so as to vary over time and/or temperature. In some embodiments, the threshold voltage 175 may be controlled by a power control unit associated with the processor 120, or another control module of a computer system.

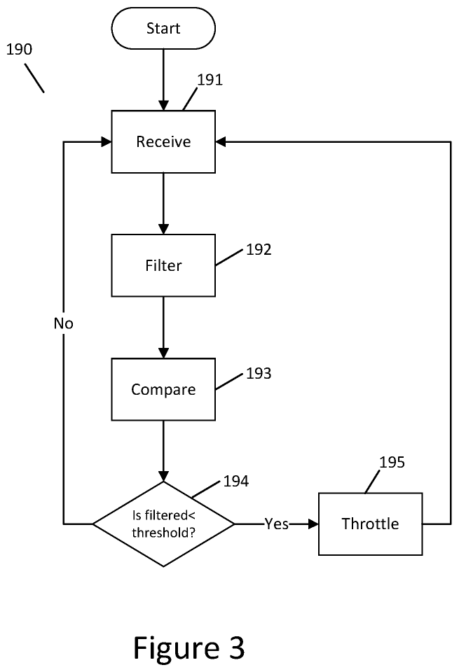

FIG. 3 illustrates a voltage protection method 190 according to an embodiment of the invention. The voltage protection method 190 may be performed by a voltage protection apparatus 100, 150 according to an embodiment of the invention.

The method 190 comprises a block 191 of receiving an input voltage provided to a processor 120. The input voltage may be received at an input 135, 165 of the voltage protection apparatus 160.

The method 190 comprises a block 192 of filtering the input voltage provided to is the processor 120 to provide a filtered input voltage. The block 192 may comprise passing the received input voltage through the filter 180, such as to low-pass filter the input voltage, although it will be appreciated that other types of filter may be used.

The method 190 comprises a block 193 of comparing the filtered input voltage to a threshold voltage 175. Block 193 may comprise determining whether the filtered input voltage, such as low-frequency components thereof, droop below the threshold voltage 175. If so, the method moves to block 195. Otherwise the method may return to block 191.

Block 195 comprises throttling the processor 120. The throttling 195 is performed in dependence on the filtered input voltage being below the first threshold voltage, as determined in block 194 to reach block 195. Following the throttling in block 195 the method may return to block 191 to receive the input voltage to the processor 191 i.e. to determine if the input voltage changes responsive to the throttling.

Embodiments of the present invention may comprise computer executable instructions which, when executed by a computer, are arranged to perform a method according to an embodiment of the invention such as that described with reference to FIG. 3. The computer executable code may comprise computer readable instructions, which may be tangibly stored on a computer readable medium.

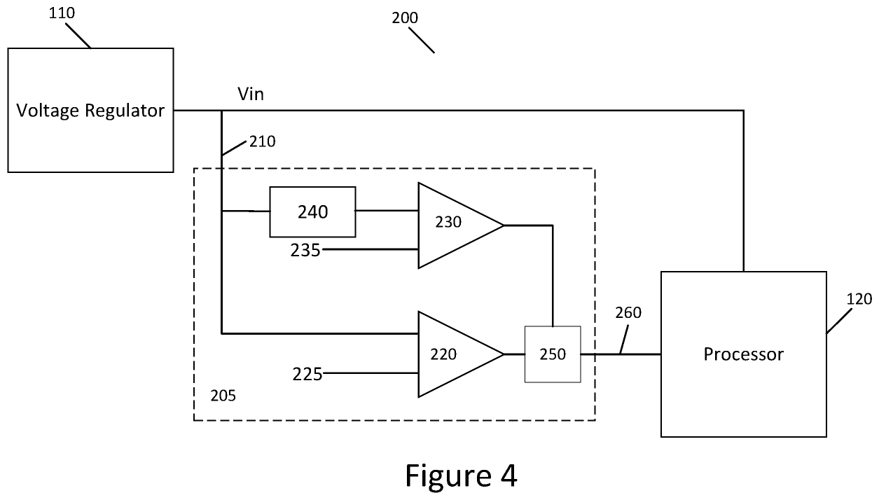

FIG. 4 schematically illustrates another embodiment of the voltage protection system 130 shown in FIG. 1. The voltage protection system 200 shown in FIG. 4 comprises the VR 110, the processor 120 and the voltage protection apparatus 205, 130 as described above. The voltage protection apparatus 205 comprises an input 210 to receive a signal indicative of the input voltage Vᵢₙ. The voltage protection apparatus 205 comprises an output 260 to output a throttle signal 260 to the processor 120. The throttle signal 260 is output in dependence on the input voltage Vᵢₙ to the processor 120. The voltage protection apparatus 205 comprises a first circuit 230, 240 to compare a filtered input voltage to a first threshold voltage 235 and a second circuit 220 to compare the input voltage provided to the processor 120 to a second threshold voltage 225

The voltage protection apparatus 205 is illustrated in FIG. 4 to comprise a plurality of comparators 220, 230. The embodiment of FIG. 4 comprises two comparators 220, 230 with it being appreciated that this is not limiting.

In the embodiment of FIG. 4 the first circuit 230, 240 of the voltage protection apparatus 205 comprises a first comparator 220 and the second circuit 230 of the voltage protection apparatus 205 comprises a second comparator 230. The first circuit of the voltage protection 205 apparatus comprises a filter 240. The filter 240 is arranged to filter an input to at least one comparator 230. The filter 240 is arranged to receive the input voltage, Vᵢₙ, provided to the processor 120 from the input 210 and to generate a filtered input voltage, V_{fil}, which is provided to the at least one comparator 230. In the embodiment shown in FIG. 4, the filter 240 is arranged at an input of the first comparator 230 to provide the filtered input voltage to the first comparator 230. The filter 240 may be a low-pass filter (LPF), although other types of filter may be envisaged in other embodiments as noted above. With the LPF 240, the first comparator 230 is provided with a low-frequency component, i.e. below a cut-off frequency, of the input voltage Vᵢₙ at the input 210. As shown in FIG. 4 Vᵢₙ is provided directly to the second comparator 220 and V_{fil} is provided to the first comparator 230.

Each of the comparators 220, 230 of the voltage protection apparatus 205 is provided with a threshold voltage 225, 235. Each comparator 220, 230 compares the respective threshold voltage 225, 235 against the filtered input voltage or the input voltage to the processor 120, respectively. In the embodiment shown in FIG. 4 the first comparator 230 is arranged to receive V_{fil} from an output of the filter 240 to compare V_{fil} against the first threshold voltage 235. The second comparator 220 is arranged to compare Vᵢₙ received at the input 210 against a second threshold voltage 225. The first and second threshold voltages may have a predetermined relationship. In some embodiments the first threshold voltage 235 is a higher voltage than the second threshold voltage 225. That is, the first threshold voltage 235 provided to the first comparator 230 is greater than the is second threshold voltage 225 provided to the second comparator 220. Thus V_{fil} is compared against a higher threshold voltage Vᵢₙ than by the voltage protection apparatus of one embodiment.

An output of each of the comparators 220, 230 is provided to a combining module 250 which is arranged to control the output 260 of the voltage protection apparatus 205 to assert the throttle input of the processor 120. The combining module 250 is arranged to combine the output signals from the comparators 220, 230 according to a predetermined relationship, such as a logic function, and to assert the throttle signal 260 in dependence thereon. The throttle signal at the output 260 of the voltage protection apparatus 205 is indicative of an input voltage to one or both of the comparators 220, 230 falling below the respective threshold voltage 225, 235. In some embodiments, the combining module 250 may implement an OR function of the outputs of the comparators 220, 230. In such embodiments, the throttle signal at the output 250 represents an OR of an output of each of the comparators 220, 230 included within the voltage protection apparatus 205. Thus the throttle signal 250 at the output 250 is asserted if either of the comparators 220, 230 determines its input voltage to fall below the respective threshold voltage 225, 235. However other relationships may be envisaged such as an AND logic function of the comparator outputs.

The first comparator 230 in some embodiments only receives, and responds to, low-frequency components of the voltage provided to the processor 120. In contrast, the second comparator 220 receives all frequency signals of the input voltage, but since its respective second threshold voltage 225 is lower than the first threshold voltage 235 in some embodiments, effectively results in the second comparator 220 throttling the processor 120 when high-frequency components of the input voltage droop below the second threshold voltage 225.

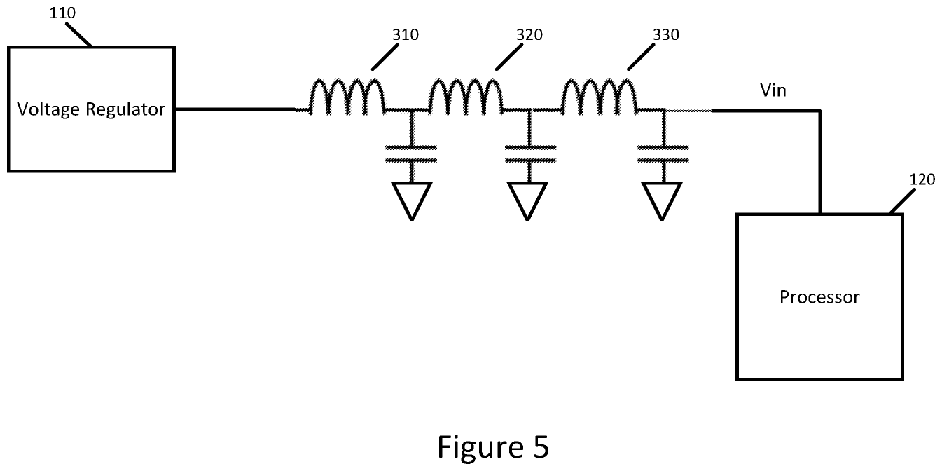

FIG. 5 is a representation of an example impedance network 310, 320, 330 between the VR 110 and the processor 120 which will be used to explain operation of voltage protection apparatus according to embodiments of the present invention. The impedance network 310, 320, 330 may be greater than second order. In the illustrated example, the impedance network 310, 320, 330 is a 6^{th}-order impedance. In the illustration of FIG. 3 the impedance network 310, 320, 330 is formed by three LC pairs 310, 320, 330. A first LC pair 310 represents a bandwidth of the VR 110, a second LC pair 320 represents impedance of motherboard circuitry of the processor 120 and a third LC pair 330 represents a semiconductor die of the processor 120. It will be appreciated that the illustration of FIG. 5 is a representation and that other impedances may be considered.

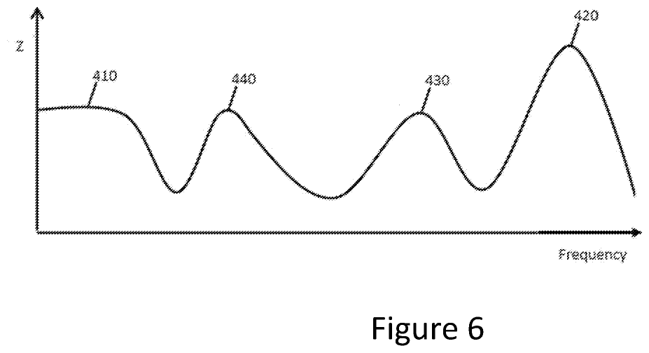

FIG. 6 illustrates impedance against frequency of the impedance network 310, 320, 330 shown in FIG. 5 as seen by the processor 120. The impedance illustrated in FIG. 6 comprises a DC or low frequency impedance 410, a first high-frequency impedance 420 which may be in a range of 100-150 MHz, a second high-frequency impedance 430 which may be in a range of 10-20 MHz and a third high-frequency impedance 430 which may be in a range of 100-300 kHz. It will be appreciated that the frequency ranges are only examples and are not limiting. The actual bounds of the frequency ranges are dependent on the parameters of a Power Delivery Network implemented in a given system, such as platform, package and die.

It is speculated that some perturbations in the processor 120 current discharge decoupling at lower frequencies i.e. the frequency of the second or third high-frequency impedances 420, 430 and, after a delay, an additional voltage droop is caused by a combination of current fluctuations. If the current fluctuation is fast enough, an additional high-frequency voltage droop is caused in addition to a low frequency voltage droop.

In the embodiment shown in FIG. 4, where the filter 240 is a LPF the first comparator 230 is a ‘slow’ comparator 230 which is responsive to low-frequency voltage droop and the second comparator 220 represents a ‘fast’ comparator which is responsive to high-frequency voltage droop. The first comparator 230 is responsive only to low frequency voltage droop due to the low-pass filter 240. The second threshold voltage 225 provided to the fast comparator 220 is in some embodiments lower than the first threshold voltage 235 provided to the ‘slow’ comparator 220.

Advantageously, voltage protection apparatus according to embodiments of the present invention reduce a likelihood of the processor 120 being throttled, which may improve performance of the processor 120. For slower perturbations of the input voltage, the ‘slow’ comparator 230 is responsive to throttle the processor 120. Fast transients in input voltage droop, the ‘fast’ comparator 220 is responsive, but at a lower voltage. A lower likelihood of throttling means that, for some application executed by the processor 120, less throttling will occur. Consequently, there is a lower likelihood of the input voltage being raised to reduce excessive throttling of the processor 120.

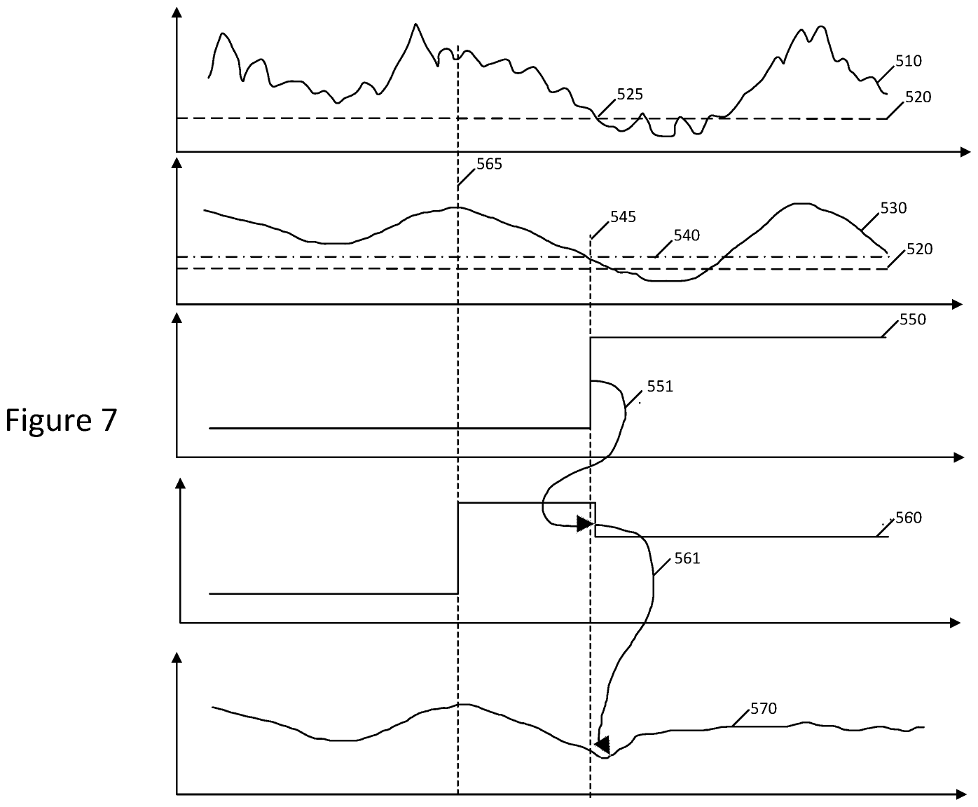

FIG. 7 illustrates operation of the voltage protection apparatus 130, 160, 205 according to embodiments of the present invention described above. By way of explanation, operation of the voltage protection apparatus 160 described in FIG. 2 will be provided with it being appreciated that the teaching of FIG. 7 extends to other embodiments of the invention.

FIG. 7 illustrates an input voltage, Vᵢₙ, 510 provided to the processor 120 over a period of time without a voltage protection apparatus according to an embodiment of the invention. Also illustrated in relation to the input voltage 510 is a minimum voltage level Vₘᵢₙ 520 required for the processor 120 to operate. As can be appreciated, for an initial period, although varying in magnitude, the input voltage 510 remains above the minimum voltage level 520 until dropping below the minimum voltage level 520 at a point in time 525. The input voltage 510 is caused to generally fall or decline by an increase in processor load, such as an abrupt increase in processor load 560 at time 565 indicated in FIG. 7. When the input voltage 510 falls below the minimum voltage level 520 the processor 120 may fail to operate correctly.

Voltage waveform 530 represents the filtered input voltage V_{fil} discussed above which, in the example of FIG. 7, is a low-pass filtered (LPF) version of the input voltage 510, such as provided to the comparator 170 illustrated in FIG. 2. The filtered input voltage 530 is shown in relation to the minimum voltage level 520 and a threshold voltage 540 provided to the comparator 170. As can be appreciated, prior to the input voltage 510 falling below the minimum voltage level 520 at time 525, the filtered input voltage 530 falls below the threshold voltage 540. If no action is taken by the voltage protection apparatus, the filtered input voltage would also eventually fall below the minimum voltage level 520 which would result in a malfunction of the processor 120. However, when the filtered input voltage 530 falls below the threshold voltage 540 at time 545, the comparator 170 is arranged to assert the throttle signal 550 to the processor 120 as illustrated in FIG. 7.

As noted above, FIG. 7 illustrates the load 560 behavior of the processor 120 according to an embodiment of the invention. As can be appreciated at time 565 the load behavior of the processor increases abruptly, causing a decrease in the input voltage 510 to the processor 120. When the throttle signal 550 is asserted by the voltage protection apparatus at time 545, the load of the processor 120 is caused to decrease responsive throttling of the processor in dependence on assertion of the throttle signal 550 as indicated by arrow 551.

Also illustrated in FIG. 7 is an input voltage to the processor 120 with a voltage protection apparatus 160 according to an embodiment of the invention. Up to approximately time 545 when the throttle signal is asserted, filtered input voltage waveform 570 is identical to voltage waveform 530. As can be seen, following assertion of the throttle signal 550 at time 545 and corresponding decrease in the load 560 of the processor 120, the filtered input voltage 570 is caused to rise resulting from the throttling of the processor 120 and consequent decrease in load current after time 545, thereby reducing a likelihood of the processor 120 failing to operate correctly. That is, the load current of the processor 120 is reduced after time 545 owing to the assertion of the throttle signal 550 by the voltage protection apparatus, which results in Vᵢₙ to the processor 120 rising, as indicated by the filtered input voltage waveform 570, in dependence on the reduced processor load as indicated by arrow 561. Therefore the minimum voltage level 520 is not crossed and the processor 120 remains functional. In contrast, as can be seen from voltage waveform 510, without the voltage protection apparatus Vᵢₙ falls below Vₘᵢₙ 520 which causes malfunctioning of the processor 120.

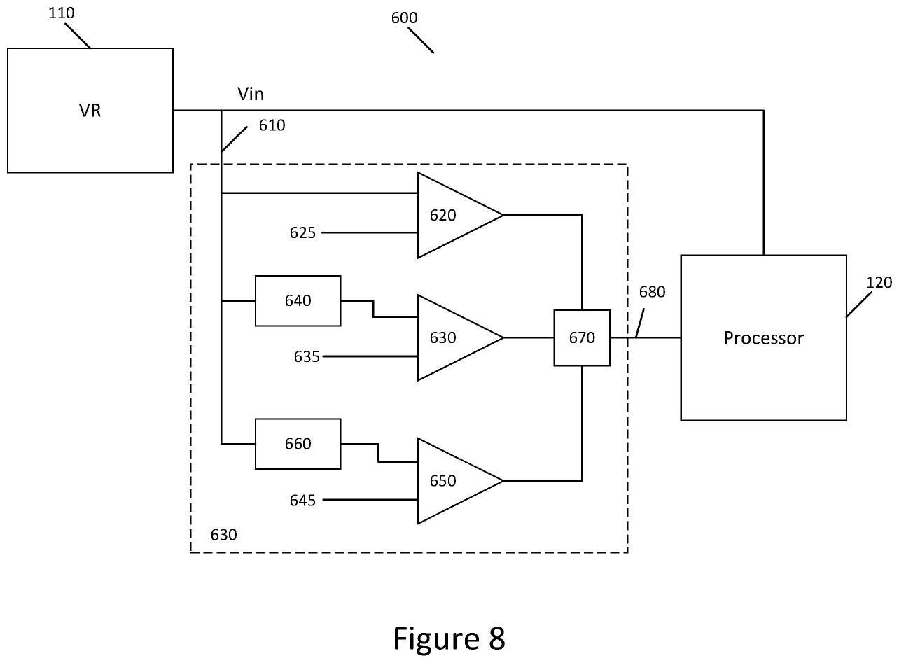

FIG. 8 schematically illustrates a voltage protection system 600 according to another embodiment of the invention. The voltage protection system 600 comprises is a VR 110, a processor 120 and a voltage protection apparatus 630 according to an embodiment of the invention.

The voltage protection apparatus 630 shown in FIG. 8 comprises an input 610 to receive the input voltage Vᵢₙ to the processor 120. The voltage protection apparatus 630 comprises an output 680 to output a throttle signal to the processor 120, as in the previously described embodiments. The throttle signal 680 is output in dependence on the input voltage Vᵢₙ to the processor 120. The voltage protection apparatus 630 comprises a plurality of circuits or circuitry 630, 640, 650, 660 to compare a plurality of filtered versions of the input voltage at the input 610 to a respective plurality of threshold voltages 635, 645. In particular, the voltage protection apparatus 630 comprises two or more circuits 630, 640, 650, 660 to compare filtered versions of the input voltage at the input 610 to respective two or more threshold voltages 635, 645. The embodiment illustrated in FIG. 6 comprises two circuits 630, 640 and 650,660 to compare two filtered versions of the input voltage to the processor 120 at the input 610 to two threshold voltages 635, 645, with it being appreciated that this is merely an example.

The voltage protection apparatus 630 illustrated in FIG. 8 further comprises a circuit 620 to compare the input voltage provided to the processor 120 to a threshold voltage 625. However it will be appreciated that embodiments of the present invention are envisaged in which the comparator 620 is not present i.e. the voltage protection apparatus only comprises a plurality of circuits each comprising a filter 640, 660 and a respective comparator 630, 650.

The voltage protection apparatus 630 of FIG. 8 comprises a first circuit 630, 640 to compare a filtered input voltage V_{fil1}, which may be referred to as a first filtered input voltage V_{fil1}, to a first threshold voltage 635, and a second circuit 650, 660 to compare a filtered input voltage V_{fil2}, which may be referred to as a second filtered input voltage V_{fil2}, to a second threshold voltage 645. Each of the first and second circuits 630, 640 comprises a respective filter 640, 650.

The embodiment illustrated in FIG. 8 comprises a third circuit 620 of the voltage protection apparatus 630 comprising a third comparator 620 which is arranged to compare the input voltage Vᵢₙ to a third threshold voltage 625. Each of the first, second and third threshold voltages may differ in some embodiments. In some embodiments the first and second threshold voltages may be equal.

The first circuit 630 of the voltage protection 630 apparatus comprises a first filter 640 and a first comparator 630. The first filter 640 is arranged to provide a first filtered voltage V_{fil1} to the first comparator 630. The first filter 640 is arranged to receive the input voltage, Vᵢₙ, provided to the processor 120 from the input 610 and to generate the first filtered input voltage, V_{fil1}, which is provided to the first comparator 630. In the embodiment shown in FIG. 6, the first filter 640 is arranged at an input of the first comparator 630 to provide the first filtered input voltage to the first comparator 630. The first filter 640 may be a low-pass filter (LPF), although as noted above other types of filter may be envisaged. The first filter 640 may have an associated first cut off frequency, such that only frequency components of Vᵢₙ below the first cut off frequency are provided to the first comparator 630.

The second circuit 650, 660 of the voltage protection 630 apparatus comprises a second filter 660 and a second comparator 650. The second filter 640 is arranged to provide a second filtered voltage V_{fil2} to the second comparator 650. The second filter 660 is arranged to receive the input voltage, Vᵢₙ, provided to the processor 120 from the input 610 and to generate the second filtered input voltage, V_{fil2}, which is provided to the second comparator 650. In the embodiment shown in FIG. 6, the second filter 660 is arranged at an input of the second comparator 650 to provide the second filtered input voltage to the second comparator 650. The second filter 660 may be a second low-pass filter (LPF), a band pass filter (BPF), a band-stop filter (BSF) or a high-pass filter (HPF). The second filter 660 may have an associated second cut off frequency in one embodiment or a pass frequency band, such that frequency components of Vᵢₙ below the first cut off frequency or within the frequency band are provided to the second comparator 650.

The third threshold voltage 625 may be greater than the first and second and threshold voltages 635, 645 in some embodiments. The first second and threshold voltages 635, 645 may be different voltages. In some embodiments, the second filter 660 may have a higher cut-off frequency than the cut-off frequency of the is first filter 640. The second threshold voltage 645 may be less than the first threshold voltage. In this way, the second comparator 650 is responsive to higher-frequency voltage droop than the first comparator 630, and the first and second comparators 630, 650 are responsive to higher frequency voltage droop than the third comparator 620.

The voltage protection apparatus 630 comprises a combining module 670 which is arranged to receive an output of the comparators 620, 630, 650 of the apparatus 630, such as the first, second and third comparators 630, 650, 620 as illustrated in FIG. 8 and to output the throttle signal 680 in dependence thereon. The combining apparatus combines the outputs of the comparators according to a predetermined logic function such as an OR function.

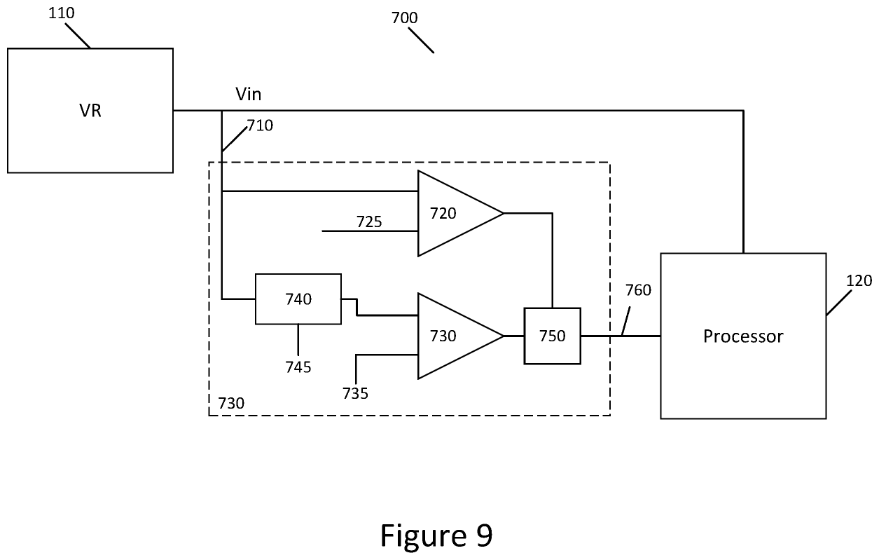

FIG. 9 schematically illustrates a voltage protection system 700 according to a further embodiment of the invention. The voltage protection system 700 shown in FIG. 7 comprises a VR 110, a processor 120 and a voltage protection apparatus 730 according to an embodiment of the invention.

The voltage protection apparatus 730 of FIG. 9 comprises an input 710 to receive a signal indicative of the input voltage Vᵢₙ. The voltage protection apparatus 730 comprises an output 760 to output a throttle signal 760 to the processor 120. The throttle signal 760 is output in dependence on the input voltage Vᵢₙ to the processor 120. The voltage protection apparatus 730 comprises a circuit 730, 740 to compare a filtered input voltage to a threshold voltage 735. The voltage protection apparatus 730 comprises a filter 740 associated with a comparator 730, as in FIG. 2. The voltage protection apparatus 730 has a structure and components consistent with that illustrated in FIG. 4 and the reader is directed the description associated therewith unless described below. Whilst FIG. 9 shows one comparator 730 associated with a filter 740 it will be appreciated that in some embodiments, the voltage protection apparatus 730 may comprise more than one comparator associated with a filter as in the embodiment shown in FIG. 8. Also illustrated in FIG. 9 is a second circuit 720 to compare the input voltage provided to the processor 120 to a second threshold voltage 725, although it will be appreciated that embodiments may be envisaged with only circuitry having a filter associated with a comparator. In the illustrated embodiment, the voltage protection apparatus comprises a combining module 750, which may be omitted in some embodiments.

The filter 740 in the embodiment of FIG. 9 is configurable according to an input 745. The filter 740 may be a low-pass filter (LPF) where the input 745 is configured to receive a signal indicative of one or more parameters of the filter, such as a cut-off frequency of the filter 740. Although not specifically shown in FIG. 9 the input 745 to the filter 740 may be provided in some embodiments from the processor 120 to set the one or more parameters of the filter of the filter 765. In this way, the processor 120 is able to configure the voltage protection apparatus 730 to reduce droop of the input voltage Vᵢₙ having one or more frequency characteristics, such as high-frequency droop.

Where functional units have been described as circuitry, the circuitry may be general purpose processor circuitry configured by program code to perform specified processing functions. The circuitry may also be configured by modification to the processing hardware. Configuration of the circuitry to perform a specified function may be entirely in hardware, entirely in software or using a combination of hardware modification and software execution. Program instructions may be used to configure logic gates of general purpose or special-purpose processor circuitry to perform a processing function.

Circuitry may be implemented, for example, as a hardware circuit comprising custom Very Large Scale Integrated, VLSI, circuits or gate arrays, off-the-shelf semiconductors such as logic chips, transistors, or other discrete components. Circuitry may also be implemented in programmable hardware devices such as field programmable gate arrays, FPGA, programmable array logic, programmable logic devices, A System on Chip, SoC, or the like.

Machine readable program instructions may be provided on a transitory medium such as a transmission medium or on a non-transitory medium such as a storage medium. Such machine readable instructions (computer program code) may be implemented in a high level procedural or object oriented programming language. However, the program(s) may be implemented in assembly or machine language, if desired. In any case, the language may be a compiled or interpreted language, and combined with hardware implementations.

### EXAMPLES

The following examples pertain to the present technique.

1. A voltage protection apparatus, comprising:
an input to receive an input voltage provided to a processor;
an output to output a throttle signal to the processor;
a filter circuit to filter the input voltage provided to the processor to provide a filtered input voltage;
a first circuit to compare the filtered input voltage to a first threshold voltage and to cause the output to provide the throttle signal to the processor indicative of the filtered input voltage dropping below the first threshold voltage.

2. The voltage protection apparatus which may be the subject-matter of example 1, comprising:
a second circuit to compare the input voltage provided to the processor to a second threshold voltage and to cause the output to provide the throttle signal to the processor indicative of the input voltage dropping below the second threshold voltage.

3. The voltage protection apparatus which may be the subject-matter of example 1 or 2, comprising, wherein the filter circuit is a low pass filter circuit.

4 The voltage protection apparatus which may be the subject-matter of example 1 or 2, wherein the filter circuit is one of a band-pass or a band-stop filter circuit.

5. The voltage protection apparatus which may be the subject-matter of example 1 or 2, wherein the filter circuit is a high-pass filter circuit.

6. The voltage protection apparatus which may be the subject-matter of any preceding example, wherein the first threshold voltage is greater than the second threshold voltage.

7. The voltage protection apparatus which may be the subject-matter of any preceding example, wherein the first threshold voltage is greater than a minimum supply voltage of the processor.

8. The voltage protection apparatus which may be the subject-matter of any preceding example, wherein the first circuit comprises a comparator to compare the filtered input voltage to the first threshold voltage.

9. The voltage protection apparatus which may be the subject-matter of example 8, wherein an output of the comparator of the first circuit is arranged to cause the first circuit to provide the throttle signal to the processor.

10. The voltage protection apparatus which may be the subject-matter of example 2 or any example thereof, wherein the second circuit comprises a comparator to compare the filtered input voltage to the second threshold voltage.

11. The voltage protection apparatus which may be the subject-matter of example 10, wherein an output of the comparator of the second circuit is arranged to cause the second circuit to provide the throttle signal to the processor.

12. The voltage protection apparatus which may be the subject-matter of any preceding example, comprising:
one or more further filter circuits to filter the input voltage provided to the processor to provide respective filtered input voltages;
one or more further circuits to each compare one of the respective filtered input voltages to a respective threshold voltage and to cause the output to provide the throttle signal to the processor indicative of the respective filtered input voltage dropping below the respective threshold voltage.

13. The voltage protection apparatus which may be the subject-matter of example 12, wherein each of the one more further circuits is arranged to each compare one of the respective filtered input voltages to a respective threshold voltage.

14. The voltage protection apparatus which may be the subject-matter of example 13, wherein each of the one or more further filter circuits has a respective frequency response profile.

15. A voltage protection method, comprising:
receiving an input voltage provided to a processor;
filtering the input voltage provided to the processor to provide a filtered input voltage;
comparing the filtered input voltage to a first threshold voltage; and
throttling the processor in dependence on the filtered input voltage dropping below the first threshold voltage.

16. The voltage protection method which may be the subject-matter of example 15, comprising:
comparing the input voltage provided to the processor to a second threshold voltage; and
throttling the processor in dependence on the input voltage dropping below the second threshold voltage.

17. The voltage protection method which may be the subject-matter of example 15 or 16, wherein the filtering comprises a low pass filtering the input voltage to provide the filtered input voltage.

18. The voltage protection method which may be the subject-matter of example 15, 16 or 17 comprising:
filtering the input voltage provided to the processor to provide one or more further filtered input voltages;
comparing each of the one or more further filtered input voltages to a respective threshold voltage; and
throttling the processor in dependence on one of the one or more further filtered input voltages dropping below the respective threshold voltage.

19. A voltage protection system, comprising:
a processor;
circuitry to filter an input voltage provided to the processor to provide a filtered input voltage and to compare the filtered input voltage to a first threshold voltage, and to provide a throttle signal to the processor indicative of the filtered input voltage dropping below the first threshold voltage.

20. The voltage protection system of which may be the subject-matter of example 19, comprising circuitry to compare the input voltage provided to the processor to a second threshold voltage, and to provide the throttle signal to the processor indicative of the input voltage dropping below the second threshold voltage.

1.-20. (canceled)

21. A voltage protection apparatus, comprising:
an input to receive an input voltage provided to a processor;
an output to output a throttle signal to the processor;
a filter circuit to filter the input voltage provided to the processor to provide a filtered input voltage; and
a circuit to compare the filtered input voltage to a threshold voltage and to cause the output to provide the throttle signal to the processor indicative of the filtered input voltage dropping below the threshold voltage.

22. The voltage protection apparatus as claimed in claim 21, wherein the circuit is a first circuit and the threshold voltage is a first threshold voltage, and wherein the voltage protection apparatus further comprises:
a second circuit to compare the input voltage provided to the processor to a second threshold voltage and to cause the output to provide the throttle signal to the processor indicative of the input voltage dropping below the second threshold voltage.

23. The voltage protection apparatus as claimed in claim 21, wherein the filter circuit is a low pass filter circuit.

24. The voltage protection apparatus as claimed in claim 21, wherein the filter circuit is one of a band-pass or a band-stop filter circuit.

25. The voltage protection apparatus as claimed in claim 21, wherein the filter circuit is a high-pass filter circuit.

26. The voltage protection apparatus as claimed in claim 22, wherein the first threshold voltage is greater than the second threshold voltage.

27. The voltage protection apparatus as claimed in claim 21, wherein the threshold voltage is greater than a minimum supply voltage of the processor.

28. The voltage protection apparatus as claimed in claim 21, wherein the circuit comprises a comparator to compare the filtered input voltage to the threshold voltage.

29. The voltage protection apparatus as claimed in claim 28, wherein an output of the comparator of the circuit is arranged to cause the circuit to provide the throttle signal to the processor.

30. The voltage protection apparatus as claimed in claim 22, wherein the second circuit comprises a comparator to compare the filtered input voltage to the second threshold voltage.

31. The voltage protection apparatus as claimed in claim 30, wherein an output of the comparator of the second circuit is arranged to cause the second circuit to provide the throttle signal to the processor.

32. The voltage protection apparatus as claimed in claim 21, comprising:
one or more further filter circuits to filter the input voltage provided to the processor to provide respective filtered input voltages;
one or more further circuits to each compare one of the respective filtered input voltages to a respective threshold voltage and to cause the output to provide the throttle signal to the processor indicative of the respective filtered input voltage dropping below the respective threshold voltage.

33. The voltage protection apparatus as claimed in claim 32, wherein each of the one more further circuits is arranged to each compare one of the respective filtered input voltages to a respective threshold voltage.

34. The voltage protection apparatus as claimed in claim 33, wherein each of the one or more further filter circuits has a respective frequency response profile.

35. A voltage protection method, comprising:
receiving an input voltage provided to a processor;
filtering the input voltage provided to the processor to provide a filtered input voltage;
comparing the filtered input voltage to a threshold voltage; and
throttling the processor in dependence on the filtered input voltage dropping below the threshold voltage.

36. The voltage protection method as claimed in claim 35, wherein the threshold voltage is a first threshold voltage, and wherein the voltage protection method further comprises:
comparing the input voltage provided to the processor to a second threshold voltage; and
throttling the processor in dependence on the input voltage dropping below the second threshold voltage.

37. The voltage protection method as claimed in claim 35, wherein the filtering comprises low pass filtering the input voltage to provide the filtered input voltage.

38. The voltage protection method as claimed in claim 35, further comprising:
filtering the input voltage provided to the processor to provide one or more further filtered input voltages;
comparing each of the one or more further filtered input voltages to a respective threshold voltage; and
throttling the processor in dependence on one of the one or more further filtered input voltages dropping below the respective threshold voltage.

39. A voltage protection system, comprising:
a processor;
circuitry to filter an input voltage provided to the processor to provide a filtered input voltage and to compare the filtered input voltage to a threshold voltage, and to provide a throttle signal to the processor indicative of the filtered input voltage dropping below the threshold voltage.

40. The voltage protection system of claim 39, wherein the circuitry is a first circuitry and the threshold voltage is a first threshold voltage, and wherein the voltage protection system further comprises second circuitry to compare the input voltage provided to the processor to a second threshold voltage, and to provide the throttle signal to the processor indicative of the input voltage dropping below the second threshold voltage.
